(19) United States
(12) Patent Application Publication
(10) Pub. No.: US 2005/0191389 A1
(43) Pub. Date: Sep. 1, 2005

(54) Flavoring matrix compositions, methods for preparing the same, methods for using the same, and food prepared from the same

(75) Inventors: Constance A. Jones, Forest Hill, MD (US); Milda E. Embuscado, Cockeysville, MD (US); James P. Farace, Glenville, PA (US); Dana D. Gasiorowski, Baltimore, MD (US); Jill B. Stankiewicz, Baltimore, MD (US)

Correspondence Address: OBLON, SPIVAK, MCCLELLAND, MAIER & NEUSTADT, P.C., 1940 DUKE STREET, ALEXANDRIA, VA, 22314, US

(73) Assignee: McCormick & Company, Sparks, MD (US)

(21) Appl. No.: 11/050,682

(22) Filed: Feb. 7, 2005

Related U.S. Application Data
(60) Provisional application No. 60/541,948, filed on Feb. 6, 2004.

(51) Int. Cl. A23L 1/27

(52) U.S. Cl. 426/250

(57) ABSTRACT

Flavoring matrix compositions, comprising: (a) a flavoring or seasoning; and (b) an edible, meltable matrix, wherein said seasoning is distributed within the matrix and wherein said composition exists in the form of a sheet, are particularly effective for adding a seasoning to a food.

### BACKGROUND OF THE INVENTION

1. Field of the Invention

The present invention relates to flavoring matrix compositions, which are useful for preparing food products. The present invention also relates to method for preparing such flavoring matrix compositions. The present invention further relates to methods for using such flavoring matrix compositions and foods prepared from such flavoring matrix compositions.

2. Discussion of the Background

When preparing food, it is often desirable to coat the surface of the food with a flavor or seasoning prior to, during, or immediately after cooking. For example, it is often desirable to season the surface of meat, such as chicken, prior to broiling.

However, the application of the seasoning can be messy and a portion of the flavoring or seasoning may be lost by falling off the meat either during application to the surface or during cooking. Moreover, it is often difficult to control the amount of flavoring or seasoning which is applied to the surface of the meat and/or adheres to the surface of the meat.

Thus, there remains a need for a composition which permits the convenient application of a flavoring or seasoning to a food. In particular, there remains a need for a composition which may be used to add an easily controllable amount of flavoring or seasoning to the surface of food. There also remains a need for a method for preparing such a composition. There also remains a need for a convenient method for adding a flavoring or seasoning to a food. There also remains a need for the food prepared from such a composition.

### SUMMARY OF THE INVENTION

Accordingly, it is one object of the present invention to provide novel flavoring or seasoning compositions.

It is another object of the present invention to provide novel flavoring or seasoning compositions which permit the addition of a flavoring or seasoning to a food.

It is another object of the present invention to provide novel flavoring or seasoning compositions which permit the addition of a flavoring or seasoning to the surface of a food.

It is another object of the present invention to provide novel flavoring or seasoning compositions which permit the addition of a flavoring or seasoning to a food in an easily controllable amount.

It is another object of the present invention to provide novel flavoring or seasoning compositions which permit the addition of a flavoring or seasoning to a food with a reduced tendency for loss and/or waste of the flavoring or seasoning.

It is another object of the present invention to provide novel flavoring or seasoning compositions which will protect sensitive flavorings or seasonings from excessive physical conditions such as high heat and/or high pressures.

It is another object of the present invention to provide novel methods for preparing such a flavoring or seasoning composition.

It is another object of the present invention to provide novel methods of using such a flavoring or seasoning composition.

It is another object of the present invention to provide novel methods for adding a flavoring or seasoning to a food.

It is another object of the present invention to provide novel foods which have been prepared by such a method.

It is another object of the present invention to provide novel foods which have been prepared by using such a flavoring or seasoning composition.

These and other objects, which will become apparent during the following detailed description, have been achieved by the inventors' discovery that flavoring matrix compositions, comprising:
(a) a flavoring or seasoning; and
(b) an edible, meltable matrix,
   wherein said flavoring or seasoning is distributed within the matrix and wherein said composition exists in the form of a sheet,
   are particularly effective for adding a seasoning to a food.

The inventors have also discovered that such compositions may be prepared by a process comprising:
(1) heating a mixture of an edible, meltable matrix material and potable liquid, to obtain a first liquid mixture;
(2) adding a flavoring or seasoning to said first liquid mixture, to obtain a second liquid mixture; and
(3) cooling said second liquid mixture, to obtain said flavoring matrix composition.

The inventors have also discovered that a seasoned food may be conveniently prepared by a process comprising:
(1) adding a flavoring matrix composition to a surface of a food,
   wherein said flavoring matrix composition comprises:
(a) a flavoring or seasoning; and
(b) an edible, meltable matrix,
   wherein said flavoring or seasoning is distributed within the matrix and wherein said composition exists in the form of a sheet.

The inventors have also found that food products, which comprise:
(A) a portion of food; and
(B) a flavoring matrix composition on at least one surface of said portion of food,
   wherein said flavoring matrix composition comprises:
(a) a flavoring or seasoning; and
(b) an edible, meltable matrix,
   wherein said flavoring or seasoning is distributed within the matrix and wherein said composition exists in the form of a sheet,
   are particularly attractive from a number of view points.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 shows one embodiment of a flavoring matrix composition according to the present invention; and

FIG. 2 shows another embodiment of a flavoring matrix composition according to the present invention.

### DETAILED DESCRIPTION OF THE PREFERRED EMBODIMENTS

Thus, in a first embodiment, the present invention provides novel flavoring matrix compositions, comprising:
(a) a flavoring or seasoning; and
(b) an edible, meltable matrix,
   wherein said seasoning is distributed within the matrix and wherein said composition exists in the form of a sheet.

The term seasoning used as in the present compositions refers to any type of flavoring agent. Suitable flavoring agents include spice oleoresins and oils derived from allspice, annatto, basil, cardamom, capsicum, cinnamon, cloves, cumin, dill, garlic, marjoram, nutmeg, paprika, black pepper, rosemary and turmeric; essential oils: anise oil, caraway oil, clove oil, eucalyptus oil, fennel oil, garlic oil, ginger oil, peppermint oil, onion oil, pepper oil, rosemary oil, and spearmint oil; citrus oils such as orange oil, lemon oil, bitter orange oil, tangerine oil, grapefruit oil, blood orange oil, and lime oil; alliaceous flavors: garlic, leek, chive, onion, and shallots; botanical extracts: arnica flower extract, chamomile flower extract, hops extract, and marigold extract; botanical flavor extracts: blackberry, chicory root, cocoa, coffee, kola, licorice root, rose hips, sassaparilla root, sassafras bark, tamarind and vanilla extracts; protein hydrolysates: hydrolyzed vegetable protein (HVPs), meat protein hydrolysates, milk protein hydrolysates; and compounded flavors both natural and artificial including those disclosed in S. Heath, Source Book of Flavors, Avi Publishing Co. Westport, Conn., pp. 149-277, 1981, which is incorporated herein by reference. Specific extracts include: baker's imitation vanilla, imitation almond extract, imitation black walnut extract, imitation butter flavor, imitation coconut extract, imitation pineapple extract, imitation strawberry extract, imitation vanilla extract, pure almond extract, pure lemon extract, pure peppermint extract, root beer concentrate, clear imitation vanilla extract, imitation banana extract, imitation brandy extract, imitation cherry extract, imitation maple flavor, imitation rum extract, imitation vanilla butter & nut flavor, mint extract, pure anise extract, pure orange extract, and pure vanilla extract. Savory extracts such as beef extract, chicken extract, turkey extract, and other extracts may also be used. Representative flavor compounds are for example: benzaldehyde, diacetyl(2,2-butanedione), vanillin, ethyl vanillin and citral (3,7-dimethyl-2,6-octadienal). The flavoring agent may be in the form of an oil, aqueous solution, non-aqueous solution or an emulsion. Flavor essences, i.e., the water-soluble fraction derived from fruit or citrus can be utilized although at lower levels than the ingredients referenced above.

The flavoring or seasoning is distributed within an edible, meltable matrix. The term edible is given its usual meaning, i.e., fit to be eaten. In the context of the present invention, the term meltable means that the matrix is a solid, semi-solid, or firm gel-like material at room temperature and a slightly elevated temperature which may be encountered under conventional storage and transportation conditions, but becomes a viscous liquid or begins to flow at temperatures at which food is cooked. Thus, in a preferred embodiment, the matrix is a solid, semi-solid, or firm gel-like material at a temperature of 25° C. and below, more preferably at 30° C. and below, even more preferably at 35° C. and below, yet more preferably at 40° C. and below, even yet more preferably at 45° C. and below. In another preferred embodiment, the matrix becomes a viscous liquid or begins to flow at a temperature of 100° C. and above, more preferably at 125° C. and above, even more preferably at 150° C. and above, yet more preferably at 175° C. and above, even yet more preferably at 200° C. and above.

Optionally, the edible, meltable matrix may be soluble. In the context of the present invention, the term soluble means that the matrix forms a homogenous liquid with an appropriate amount of solvent and at an appropriate temperature.

The edible, meltable matrix of the present compositions typically comprises some type of food polymer. Suitable food polymers include modified starches, exudate gums (arabic, ghatti, karaya, tragacanth), extract gums (β-glucans, inulins, konjac, larch), seed gums (locust bean, guar, pysllium, quince, fenugreek, tara), pectins (high methoxy-, low methoxy-, amidated), microbial gums (xanthan, curdlan, pullulan, gellan, scleroglucan, welan, rhamsan), modified celluloses (methylcellulose, hydroxypropylcellulose, hydroxypropylmethyl cellulose, sodium carboxymethyl cellulose), seaweed hydrocolloid extracts (sodium alginate, propyleneglycol alginate, modified alginate, ammonium alginate, alginic acid, carageenans (iota, ι, kappa, κ, lambda, λ)), dextrins, dextran, hydrogenated starch hydrolyzates, polydextrose, agar agar, modified agar, gelatins (both type A and B, hydrolyzed gelatin, modified gelatin), milk proteins (whole milk protein, sodium caseinate, calcium caseinate, whey proteins, albumins, lactoglobulins), pregelatinized starches, seed proteins (from soy, sunflower, cottonseed, peanut), cereal proteins (wheat, corn, oat, rice), fractionated proteins, hydrolyzed proteins, chitosan, and modified chitosan. In addition, two or more food polymers may be used together.

These food polymers are described in more detail immediately below.

The modified starches consist of a group of native starches that have been chemically or physically modified. Examples of modified starches include those esterified with n-octenylsuccinic anhydride (n-OSA), phosphorus oxychloride, or adipic aicd. Thin boiled starches, crosslinked, acetylated, hydroxypropylated, and oxidized starches are other examples of modified starches. Other examples of modified starches are PURE-COTE®, INSTANT PURE-COTE®, and n-OSA modified starches (sold under the trade names: Capsul, Hi-Cap 100, C*EmCap 12634, C*EmCap 12639, MiraCap, and National 78-0487 among others).

Dextrins, incompletely hydrolyzed starch polymers, are prepared by dry heating corn, waxy maize, waxy milo, potato, arrowhead, wheat, rice, tapicoa or sago starch. Alternatively, the dextrins can be obtained by treating the selected dry starch with suitable acid, alkali or pH control agents and then heating and drying.

Maltodextrins are also suitable carbohydrate food polymers. These polymers are derived from the partial hydrolyzed forms of corn, rice, wheat, or potato starches utilizing suitable acid or enzymatic catalysis. The maltodextrins are defined as having a Dextrose Equivalent (D.E.) of <20.

Hydrogenated starch hydrolyzates are the products obtained from the hydrolysis of a starch to generate maltodextrin oligomers. These oligomers are then hydrogenated to convert the terminal reducing sugar moiety to an oligomer with a non-reducing terminal polyol.

Polydextrose is the glucosyl homopolymer resulting from the condensation of glucose in the presence of an acidic catalyst.

Specifically the protein polymers utilized may be selected from the group of gelatins (both from acidic or basic extraction sources, hydrolyzed gelatins); milk proteins (whole milk protein, sodium caseinate, calcium caseinate, whey proteins, albumins, globulins), seed proteins (from soy, sunflower, cottonseed, peanut, rape); cereal proteins (wheat, corn, oat, rice), fractionated proteins, hydrolyzed proteins, and egg proteins.

Gelatin, the soluble protein extract from collagen, comes from various animal sources and in different forms. There are acid-extracted and base-extracted forms of gelatin. The key difference between the two forms is the isoelectric point of the resultant, soluble polymer. Sources of the collagen used for extraction to generate the gelatin include cattle hides and pork skins. The type and degree of extraction lead to various grades of gelatin. Acid hydrolysis of the collagen leads to Type A acid gelatin. Similarly base hydrolysis and extraction leads to a Type B gelatin. The isoelectric points are generally in the pH range of 7 to 9 for Type A; and 4.7 to 5.1, for Type B. Gelatins are generally characterized by their gelling strength in terms of Bloom using a standardized procedure and a Bloom gelometer. Commercial gelatins vary from 50 to 300 Bloom with the high values indicating stronger gels (see M. Glicksman, Gum Technology in the Food Industry, Academic Press, pp. 359-397, 1969). The particular gelatins which are most compatible with the extrusion encapsulation process of the present invention are the 50 to 75 Bloom gelatins of both type A and B.

Another form of gelatin is the hydrolyzed gelatins. These products are derived from the standard gelatins by an additional hydrolysis step. The result is a hydrolyzed, water soluble, non-gelling form of the food protein. Generally, molecular weights of the hydrolyzed gelatins are in the range from 10,000 to 100,000. Amidated gelatins may also be used.

Other hydrocolloid polymers include the exudate gums, gum extracts and microbial gums.

Gum arabic is an exudate gum obtained from Acacia trees. The main species are Acacia senegal and Acacia seyal. Gum arabic is a branched molecule with a main chain of (1→3)-linked-β-D-galactopyranosyl units having side chains, consisting of (1→3)-linked β-D-galactopyranosyl units, joined to it by (1→6)-linkages. The resulting side chains consist of various acidic sugars (see Industrial Gums, R. Whistler and J. BeMiller, Eds., 3rd Edition, Academic Press, pp. 311-318, 1993). The hydrocolloid shows enhanced solubility and relatively low viscosities in solutions of 30 to 40 wt. % solids. Generally, the A. senegal gum is used to make beverage emulsions, while the A. seyal gum is used for spray drying applications. In spray drying, the key functional characteristics of the polymer are its emulsifying capacity, good film-forming properties upon drying and reasonably low aqueous viscosity. One key commercial specification for the A. seyal product is the degree of color contributed by the gum. With some darker lots of the gum, a bleaching step is sometimes added to lighten the product color by oxidation. Unexpectedly it was discovered by the present inventors that unbleached A. seyal or A. senegal can be extruded in a manner which protects the freshly exited molten extrudate from flashing off flavor volatiles.

Other exudates gums include gum karaya, also known as sterculia gum, which comes from the tree Sterculia urens. This complex polysaccharide has a molecular weight as high as 9,500,000. Gum tragacanth is obtained from shrubs of the Astragalus species. Gum ghatti, the translucent exudate from Anogeissus latifolia tree, is a complex polysaccharide that hydrates in cold water, producing a translucent gel. It is also known as ‘Indian gum.’

Among the seed gum extracts is guar gum which is derived from the bean plant Cyamopsis tetragonolobus. This long-chain, linear molecule of β-1,4-D-galactomannans with α-1,6-linked D-galactose has a molecular weight of approximately 1,000,000. Locust bean gum, from Ceratonia siliqua, is a branched β-1,4-D-galactomannan with a high molecular weight. Konjac, a β-1,4-glucomannan, is derived from the roots of the elephant yam (Amorphophallus konjac). It has a molecular weight of 200,000 to 2,000,000. Tara gum, derived from the tara bush, Caesalpinia spinosa, is a galactomannan that structurally resembles guar and locust bean gums. Larch gum or arabinogalactan is the hydrocolloid extracted from the American Larch. The arabinogalactan is composed of galactose and arabinose units in a 6:1 ratio, with a trace of uronic acid. The molecular weights of the major fractions of arabinogalactan in larch gum are 16,000 and 100,000. Glycosyl linkage analysis of arabinogalactan is consistent with a highly branched structure comprising a backbone of 1,3-linked galactopyranose connected by 1,3-glycosidic linkages.

A number of hydrocolloid gums are available from the action of microbial fermentation on sugars and carbohydates. These include: xanthan gum which is a polysaccharide produced by Xanthomonas campestris bacteria. Gellan gum is a gel-forming polysaccharide derived from Pseudomonas elodea. Pullulan is a natural polysaccharide produced from starch by a yeast called Aureobasidium pullulans. Curdlan is a β-1,3-glucan produced by the microorganism Alcaligenes faecalis var.

Cellulose is the most common carbohydrate polysaccharide consisting of glucose molecules linked by ββ-1,4 linkages, and is the starting material for cellulosic gums. Microcrystalline cellulose (MCC) provides a high degree of thixotropy, which results from the large number of colloidal microcrystalline particles formed by hydrolyzing cellulose. Carboxymethylcellulose (CMC) gum, or cellulose gum, is a sodium salt derived from purified, modified cellulose.

Methylcellulose (MC), hydroxypropyl methylcellulose (HPMC), and hydroxypropyl cellulose (HPC) are cellulosic gums with methyl ether and/or hydroxypropyl derivatizing groups. The methylcellulose food polymers are a class of various substituted celluloses. A detailed characterization can be found in the ‘Methocel Cellulose Ethers’ Technical Handbook supplied the Dow Chemical Company. The molecular weight of a cellulose ether, such as methyl cellulose or hydroxypropyl methyl cellulose, is generally expressed in terms of the viscosity at 20° C. of an aqueous solution containing 2 wt. % of the cellulose ether. Suitable cellulose ethers for use are those having a viscosity of 3 to 100,000 centipoises, preferably 4000 to 15,000 centipoises. Cellulose ethers are also characterized in terms of the degree of hydroxypropoxyl and methoxyl substitution. The term “methoxy degree of substitution” (MDS) refers to the average number of methyl ether groups present per anhydroglucose unit of the cellulose molecule. The term “hydroxypropyl molar substitution” (HPMS) refers to the average number of moles of propylene oxide which are reacted with each anhydroglucose unit of the cellulose molecule. In the present invention, the methyl cellulose suitably has a MDS of from 19 to 31, preferably 27 to 31. The hydroxypropyl methyl cellulose suitably has a MDS of from 19 to 30, preferably 24 to 30, and a HPMS of from 4 to 12, preferably 7 to 12. These polymers are unique in that when in a hydrated state they are reversible thermal gelling polymers. In the context of the present invention, these polymers are placed in a low moisture, melt environment of an extruder. Under these processing conditions, plasticizers and cosolvents may assist in the melt process. It is also noted that these modified celluloses may past through the high temperature, low moisture extrusion process only partially plasticized or unplasticized. This property of limited polymer solubility in the melt extrusion process can yield beneficial properties to the present compositions. The presence of unhydrated methylcellulose particles distributed throughout the extruded glassy matrix can ultimately lead to retarded hydration by water in the application, protection of the matrix, and retarded release of encapsulated encapsulant.

CMC cellulose is prepared by the chemical reaction of sodium monochloroacetate with an alkali cellulose. The product consists of a sodium carboxymethyl groups on the hydroxy groups of the cellulose. The degree of substitution of the side groups is approximately 0.7 for food grade products. The hydrated polymer can be defined by viscosity types (high, medium, and low) which correspond to approximate polymer molecular weights of 700,000, 250,000 and 90,000 respectively. The CAS number of this material is: 9004-32-4 and the CAS name is: cellulose, carboxymethyl ether, sodium salt.

Pectin is a cell wall polysaccharide that is commercially extracted from citrus peels and apple pomace. It consists mainly of galacturonic acid and galacturonic acid methyl ester units that form linear chains. It is normally classified according to its degree of esterification—a pectin with at least 50% DE (degree of esterfication) or greater is a high-methoxy (HM) pectin, while one below a DE of 50% is a low-methoxy (LM) pectin. The two types possess different properties; for example, low-methoxy pectin requires calcium to gel. Amidated pectins (both calcium and non-calcium sensitivy forms) may also be used.

Another group of food polymers are derived from seaweed: agar agar, modified agar, the alginates, modified alginates, and the carageenans, and are useful in the present invention. The carageenan polymers are sulfate-bearing heteropolymers derived from various species of seaweeds. Carrageenans are linear sulfated galactans obtained from red seaweeds (Rhodophyceae), but since the carrageenan molecule has up to 1,000 galactose residues, it has many structures. They are generally characterized as having the kappa, lambda and iota forms and show various sensitivity to calcium and potassium in terms of gelling in the hydrated state.

Alginates are extracted from brown seaweed or kelp. The polymer extract from the specific seaweed sources yields the alginic acid form, the sodium alginate form and a chemically modified alginate: the propyleneglycol alginates. Alginate is made up of the five-carbon polymers mannuronic acid and gluronic acid. In the presence of calcium ions, it forms thermally irreversible gels.

Agar-agar is a polysaccharide derived from various species of red algae such as Sphaerococcus, Euchema and Gelidium, and contains sulfated galactose monomers.

Another carbohydrate polymer group consists of the β-glucans and inulins. β-Glucans consist of linear unbranched polysaccharides of linked β-(1→3)- and β-(1→4)-D-glucopyranose units. These polymers are obtained by extraction of oat cell wall. β-Glucans form ‘worm’-like cylindrical molecules containing up to about 250,000 glucose residues that may produce cross-links between regular areas containing consecutive cellotriose units. They form thermoreversible infinite network gels. 90% of the β-(1→4)-links are in cellotriosyl and cellotetraosyl units joined by single β-(1→3)-links with no single β-(1→4)- or double β-(1→3)-links. The ratio of cellotriosyl/cellotetraosyl is about 2.0-2.4 in oats, about 3.0 in barley, and about 3.5 in wheat.

Inulin is a fructosyl oligosaccharide polymer and has been extracted from chickory and jerusalem artichokes.

Chitosan is a linear, water-insoluble glycan derived from crustaceans and other sources. It is the deacetylated form of the chitin.

Typically, the matrix will be prepared by forming a suspension or solution of the food polymer at an elevated temperature, adding the flavoring or seasoning, and then cooling the resulting mixture. The temperature at which the matrix becomes a viscous liquid or begins to flow may be controlled to a certain extent by controlling the amount of water (or other potable liquid) added to the food polymer during preparation of the matrix. Specifically, the addition of a greater amount of water to a given food polymer will typically result in the matrix becoming a viscous liquid or beginning to flow at a lower temperature, while the addition of a lower amount of water to the same polymer will result in the matrix becoming a viscous liquid or beginning to flow at a higher temperature.

Although the exact amount of seasoning distributed in the matrix will depend, in part, upon the precise nature of the matrix, and the anticipated end use of final composition, the compositions of the present invention will typically comprise 0.5 to 75% by weight, based on the total weight of the composition, of flavoring or seasoning. Preferably, the present compositions will comprise approximately 50% by weight, approximately 40% by weight, approximately 30% by weight, approximately 20% by weight, or 1 to 15% by weight, based on the total weight of the composition, of flavoring or seasoning.

When the flavoring or seasoning is lipophilic, the seasoning may be dispersed in the matrix with the aid of an emulsifier added to the lipophilic phase or in the matrix mixture. Emulsifiers such as distilled monoglycerides, ethoxylated monoglycerides, lacylated monoglycerides, acetylated monoglycerides, diacetyl tartarate esters of monoglycerides (D.A.T.E.M.'s), propyleneglycol monoesters, sorbitan monostearate, sorbitan tristearate, polyglycerol esters, sorbitan polyoxyethylene monoester and triesters, sucrose esters, sodium stearoyl lactylate (S.S.L.), lecithin, hydroxylated lecithin, oleyl lactylic acid, lactylated esters of monoglycerides, lacylated esters of propylene glycol monoglycerides, and the sodium and potassium salts of fatty acids can be employed singly or in combination. The emulsifier(s) is used at the level of 0.1 to 10% of the selected seasoning. Preferred emulsifiers are the sorbitan polyoxyethylene monoesters.

In certain embodiments with particular food polymers, it may be preferred to include one or more oils or fats in the matrix. The inclusion of an oil or fat in the matrix may be particularly preferred when solvent and/or flavor protection is needed for volatile flavoring compounds. An exemplary solvent for providing such protection is triacetin. In addition, in some cases, an emulsion-type flavoring component will be mixed with the matrix. The emulsion-type flavoring component is made by dissolving the flavoring compounds in oil/fat, adding this to a flavor carrier solution and homogenizing the mixture. This is then added to the matrix. Typically, the oil or fat will be included in an amount of 0.5 to 30% by weight, preferably 1 to 20% by weight, more preferably 2 to 10% by weight, based on the total weight of the food polymer(s) in the matrix. Suitable oils and fats include soybean oil, canola oil, hydrogenated oils, coconut oil, olive oil, sunflower oil, other seed oils, and fruit oils.

In addition to the foregoing encapsulates, various optional ingredients such as conventionally used in the art, may be included in the compositions of the present invention. For example, colorings, sweeteners (such as sucrose and sucralose), food acids (such as malic acid and citric acid), salts (such as calcium citrate and calcium chloride), fragrances, diluents, flavor maskers, flavor enhancers, fillers, preservatives, anti-oxidants, stabilizers, lubricants, and the like may be employed herein if desired.

The present compositions take the form of a sheet. The thickness of the sheet typically ranges from 0.05 to 2.5 mm, preferably 0.1 to 1 mm, more preferably 0.25 to 0.75 mm. It should be noted that the thickness of the matrix, as originally prepared, may be much greater than the thickness of the final sheet. In particular, it is possible to obtain a matrix of the final desired thickness by cutting or slicing a block of tube of the matrix composition.

The sheet will typically exist as a square, rectangle, triangle, circle, oval, or ellipse (when looked at from the two dimensions other than the thickness). In the case of a square or rectangle, the length and width of the final sheet are typically determined by the dimensions of the food to which the seasoning composition is to be added. For example, when the sheet is intended to be added to a piece of food having a particular length and width, the sheet need not be any larger than the width and length of the piece of food. Thus, the width of the final sheet will typically range from 1 to 75 cm, preferably 2.5 to 20 cm, more preferably 5 to 15 cm, and the length of the final sheet will typically range from 1 to 75 cm, preferably 2.5 to 20 cm, more preferably 5 to 15 cm. In the case of a triangle, the sheet will typically have lengths that from 1 to 75 cm, preferably 2.5 to 20 cm, more preferably 5 to 15 cm. As noted above, it is also possible for the sheet to exist as a circle or ellipse (looked at from the two dimensions other than the thickness). In this case, the radius of the circle or ellipse will typically range from 0.5 to about 40 cm, preferably 1 to 10 cm, more preferably 2.5 to 7.5 cm, and the distance between the foci of the ellipse typically range from 0.5 to 40 cm, preferably 1 to 10 cm, more preferably 2.5 to 7.5 cm.

However, it should be recognized that the sheet as originally prepared may have a much greater size (in the dimensions other than the thickness), and that the final sheet product may be prepared by cutting a much larger sheet. In reality, the size of the sheet as originally prepared will only be limited by the limitations of the apparatus used for preparing the sheet and packaging, shipping, and storage considerations.

Typically, the sheet will have a fairly uniform appearance and composition. However, in a particularly preferred embodiment, the sheet will be marked by stripes or a cross-hatching pattern of a coloring agent. In this way, faux grill marks can be imparted to a piece of food and food can be given the appearance of having been cooked on an open grill even when it has been cooked by some other manner, i.e., in an oven. Depending on the relative densities of the flavoring or seasoning, on the one hand, and the matrix material, on the other hand, it is also possible that particulate flavorings or seasonings may settle to the bottom or rise to the top of the sheet to some degree during the preparation of the sheet. In this case, the distribution of the flavoring or seasoning may not be completely uniform when viewed along one or more of its dimensions.

In another embodiment, the present flavoring or seasoning composition may comprise two or more distinct layers. In this case, the layers may be composed of the same of different matrix materials, and may contain the same or different flavorings or seasonings.

In a particularly preferred embodiment, the flavoring matrix composition exists in the form of sheet which is perforated (or docked) with a plurality of perforations which run through the sheet along the thickness dimension. The word docking is a technical term used in the baking industry—it means that holes are made in a dough/product to keep it from expanding beyond size and/or to keep steam from being trapped and therefore making large bubbles when being baked—i.e. in single unfilled pie shells or soda crackers. Docking is typically accomplished using a roller or stamp. In the baking industry, the pattern, density, and size of docked holes depend upon the application. The docking equipment is produced by a die company and it is specific to the application—i.e. dough type, dough thickness, signature pattern of holes needed, etc. The use of docking in the baking industry is described in S. A. Matz, Cookie and Cracker Technology, Third Ed., AVI, Van Nostrand Reinhold, New York, 1992, which is incorporated herein by reference.

In the present invention, the primary purpose of docking (or perforating) is to keep steam from being trapped between the surface of the food and the composition-therefore letting the matrix melt correctly instead of being lifted off the surface because of the trapped steam. Thus, it has been found that the presence of the perforations promotes adhesion of the flavoring matrix composition and reduces the tendency of the sheet to slip or flow off the surface of the food during cooking. The presence of the perforations also facilitates the quick and even melting of the flavoring matrix composition during the cooking process.

Typically, the sheet will be perforated with holes having a diameter or greatest dimensions of 0.1 to 10 mm, preferably 0.5 to 7.5 mm, more preferably 1 to 5 mm. The perforations will typically be present on the surface of the sheet in a density of 0.5 to 2500 perforations per cm², preferably 1 to 2500 perforations per cm², more preferably 1 to 1000 perforations per cm², even more preferably 1 to 500 perforations per cm², still more preferably 1 to 100 perforations per cm², yet more preferably 1 to 50 perforations per cm², even still more preferably 1 to 25 perforations per cm², even yet more preferably 1 to 10 perforations per cm², most preferably 1 to 5 perforations per cm².

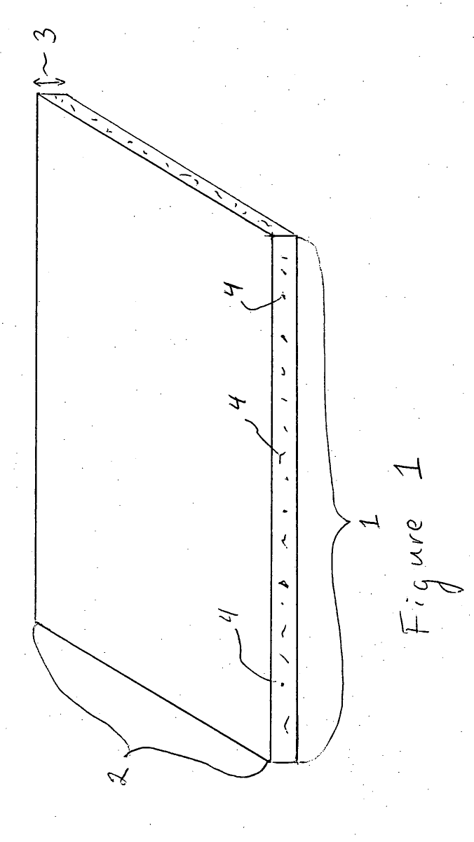

Referring now to the drawings, wherein like reference numerals designate identical or corresponding parts throughout the several views, FIG. 1 depicts one embodiment of a flavoring matrix composition according to the present invention. In FIG. 1, the flavoring matrix composition exists in the form of a rectangular sheet, which has a length, 1, a width, 2, and a thickness, 3. Particles of seasoning, 4, are distributed within the matrix.

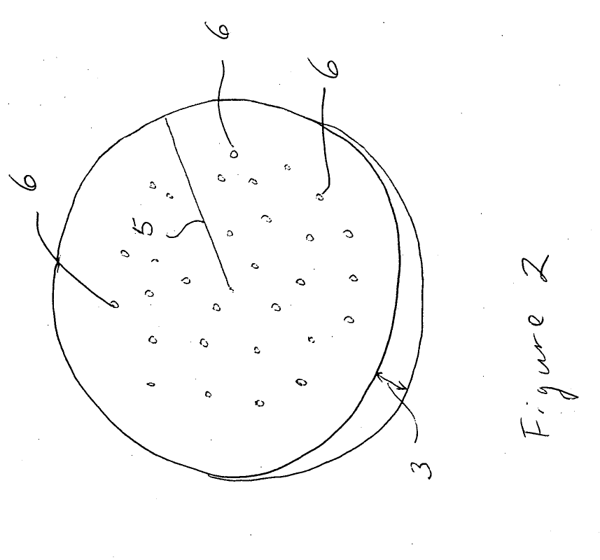

FIG. 2 depicts another embodiment of a flavoring matrix composition according to the present invention which exists in the form of a circular sheet, which has a radius, 5, and a thickness, 3. The sheet is perforated with a plurality of perforations, 6.

In another embodiment, the present invention provides a method for preparing a seasoning composition, comprising:
(1) heating a mixture of an edible, meltable matrix material and potable liquid, to obtain a first liquid mixture;
(2) adding a flavoring or seasoning to said first liquid mixture, to obtain a second liquid mixture; and
(3) cooling said second liquid mixture, to obtain the flavoring matrix composition,
   wherein said flavoring or seasoning is distributed within the matrix and wherein said composition exists in the form of a sheet.

In the present method, the seasoning, matrix, and additional components may be as described above in the context of the present compositions. Moreover, relative amounts of these ingredients may also be the same.

In the first step of the present process, the matrix material is heated with a potable liquid to obtain a first liquid mixture. Typically, the first liquid mixture will exist in the form of a solution or suspension.

The potable liquid may be any liquid which is safe for ingestion, such as water, ethyl alcohol, and mixtures thereof. Preferably, the potable liquid is an aqueous based liquid. More preferably, the potable liquid is water.

The amount of potable liquid used to form the first liquid mixture will depend on a number of factors. First, sufficient potable liquid must be used so that a liquid is formed when the mixture is heated. Specifically, it is preferred that the first liquid mixture have a viscosity low enough that the flavoring or seasoning may be conveniently mixed with the first liquid mixture without resort to specialized equipment or procedures. It is also preferred that the sufficient potable liquid be added such that the first liquid mixture is formed at a temperature which is not so high that either the matrix material or the flavoring or seasoning will be adversely affected. In addition, it is preferred that the amount of potable liquid used to form the first liquid mixture be limited so that the second liquid mixture will form a solid, semi-solid, or firm gel-like material on cooling to a temperature at or below 70° C., preferably at or below 40° C., more preferably at or below 35° C., even more preferably at or below 30° C., yet more preferably at or below 25° C., even yet more preferably at or below 20° C. Thus, the amount of potable liquid added to the matrix material will typically be 1 to 85 wt. %, preferably 2 to 40 wt. %, more preferably 5 to 30 wt. %, based on the total weight of the matrix material and potable liquid.

The temperature to which the matrix material and water are heated depends on two factors. First, the temperature must be high enough to obtain a liquid with a viscosity which is low enough that the flavoring or seasoning may be conveniently mixed with the first liquid mixture without resort to specialized equipment or procedures. Second, the temperature must not be so high that either the matrix material or the flavoring or seasoning will be adversely affected.

The first liquid mixture may be formed by simply mixing the matrix material and the potable liquid with heating in any suitable apparatus. The matrix material may be first mixed with the potable liquid and the resulting mixture heated. Alternatively, the matrix material may be added to a potable liquid which has already been heated.

After the first liquid mixture has been formed, the flavoring or seasoning is then mixed to obtain the second liquid mixture which contains both the matrix material and the flavoring or seasoning. The second liquid mixture may be formed by mixing the first liquid mixture and the flavoring or seasoning in any suitable apparatus. The flavoring or seasoning may be mixed with the first liquid mixture in the same apparatus in which the first liquid mixture was formed. It may be preferred to continue to heat the first liquid mixture while the flavoring or seasoning is being mixed. Alternatively, it may be preferred to discontinue the active heating while the flavoring is being mixed with the first liquid mixture to accelerate the cooling process.

After the second liquid mixture has been formed, it is cooled to obtain the flavoring matrix composition in which the flavoring or seasoning is distributed within the matrix. The second liquid mixture is preferably cooled to a temperature at which it becomes a solid, semi-solid, or firm gel-like material.

Alternatively, for example when specialized equipment is available such as a tank which allows for indirect heating of the ingredients, all of the ingredients may be mixed together (i.e., by in-line mixing) so that the flavoring matrix composition is formed in one continuous process. In such cases, the resulting mixture is still preferably cooled to a temperature at which it becomes a solid, semi-solid, or firm gel-like material.

In some cases, it may be necessary or desirable to remove some amount of the potable liquid either before or after the flavoring or seasoning is mixed with the first liquid material to ensure that that the final product will exist as solid, semi-solid, or firm gel-like material at the desired temperature, while still melting at the desired temperature. In such cases, some of the potable liquid may be removed by any suitable technique, including air drying, oven drying, freeze drying, etc. Preferably, after such drying has taken place, and for the purposes of achieving good shelf stability, the resulting material has the following moisture content and water activity: 0.5% to 35% moisture content and 0.15 to 0.75 water activity. Low moisture and low water activity can be achieved by drying using a convection oven set at 40-90 C for 10 minutes or longer depending on the temperature and air flow used. Faster drying can also be achieved by using a tunnel dryer using controlled temperature, relative humidity and air flow. Matrices with higher moisture content (up to 75%) and higher water activity (up to 0.95) require refrigeration.

The flavoring matrix material may be formed as a sheet directly. For example, the second liquid mixture may be cast into a mold or drawn and then cooled to form the sheet in its final desired shape. Alternatively, the second liquid mixture may be extruded or poured onto a belt to form a continuous sheet which may then be further processed, for example, by cutting to a desired shape for a particular application. Any conventional cutting apparatus may be used. In addition, the flavoring matrix composition may be initially obtained in a bulk or block form which may then be cut or sliced to obtain the desired shape for a particular application.

The sheet may also be treated with an anti-caking agent, such as silicon dioxide, starch, modified starch, modified cellulose, magnesium stearate, etc.

Although the seasoning composition may be used immediately after preparation, in most cases it will be packaged for shipping, storage, and later use. The packaging will typically be of some type of air-tight, moisture impervious material, such as a plastic, laminates, foil pouch, or bag. The package may contain a further component, such as a desiccant or an antioxidant.

The package may contain an individual sheet or a plurality of sheets. When the package contains more than one sheet, the sheets may be separated by a sheet of a different material to facilitate the separation of the sheets of seasoning composition from each other and/or to reduce the chance of the sheets of seasoning composition sticking together. This other material may be, e.g., a sheet of waxed paper or some other type of release sheet.

In a preferred embodiment, the present seasoning composition is packaged in the form of a roll of a long strip from which individual sheets may be cut or otherwise removed. In this case, it may be desired to wind the roll of the seasoning composition with a strip of another material such that adjacent layers of the seasoning composition in the final roll are separated from each other by a layer of the other material. In this way, the unwinding of the roll may be facilitated.

In another embodiment, the present invention provides a method for preparing a seasoned food, comprising:
(1) adding a flavoring matrix composition to a surface of a food,
wherein said flavoring matrix composition comprises:
(a) a flavoring or seasoning; and
(b) an edible, meltable matrix,
   wherein said flavoring or seasoning is distributed within the matrix and wherein said composition exists in the form of a sheet.

Of course, the flavoring matrix composition used in this method may be as described above.

The food to which the seasoning composition is added may be any food to which seasoning compositions are conventionally added. In a preferred embodiment, the food is a piece of fowl, meat, fish, vegetable protein, or serving of cereal grain product. Examples of the fowl, meat, fish, vegetable protein, or cereal grain product to which the seasoning composition may be added include fowl, such as chicken, turkey, ostrich, emu, quail, pigeon, and duck; meat such as beef, veal, pork, ham, lamb, rabbit, buffalo, and bison; fish such as cod, salmon, swordfish, tuna, cat fish, trout, haddock, etc; vegetable protein such as tofu, textured vegetable protein, etc.; and cereal grain products such as rice, bulgar, barley, polenta, kasha, couscous, etc. In another preferred embodiment, the food is of the size which is suitable for an individual serving, such as a chicken breast, a chicken thigh, a chicken leg, a chicken wing, a hamburger, a beef steak, a pork chop, a lamb chop, a salmon steak, a tuna steak, a swordfish steak, etc. In another embodiment, the food product is baked product, such as rolls, muffins, pastries, breads, bagels, pretzels, pizza, baked doughnuts, pies, or a dough for such a baked product.

The seasoning composition may be added to the food by simply placing it on the surface of the food by hand. Alternatively, the seasoning may be applied to the surface of the food by some automated procedure. The seasoning composition may be applied to any surface of the food, such as the top, bottom, side, or internal surfaces as appropriate.

In a preferred embodiment, the food to which the flavoring matrix composition is either uncooked or only partially cooked. In this case, the food will preferably be an uncooked or partially cooked piece of meat or fish, or a dough product. Examples of a partially cooked dough product include a boiled, but unbaked, bagel.

The flavoring material may be added to the uncooked or partially cooked piece of fowl, meat, fish, vegetable protein, cereal grain product, or dough product just prior to cooking. Alternatively, the flavoring matrix composition may be added to the food prior to freezing, the resultant food product with the flavoring matrix composition coated on the food may be frozen and stored.

The food product with the flavoring matrix composition coated on a surface of the food may then be cooked to obtain a final cooked food with a seasoned glazed surface. Preferably, the food is cooked under the normal conditions used for cooking such a food. For example, in the case of a portion of fowl, meat, fish, vegetable protein, and cereal grain product, the food product with the flavoring matrix composition coated on a surface of the food is typically cooked on a top burner, in an oven, convection oven, microwave oven, halogen oven, or under an overhead broiler. In the case of baked products, the food product with the flavoring matrix composition coated on a surface of the food is typically cooked in an oven, convection oven, microwave oven, halogen oven, or under an overhead broiler. Of course the various top burners and ovens described above may be of the domestic and/or retail type or the industrial and/or restaurant type.

During the cooking of the food product with the flavoring matrix composition coated on a surface of the food, the flavoring matrix composition will melt, i.e., become a viscous liquid or begin to flow, and form an even layer of seasoning on the surface of the food on which the flavoring matrix composition was layered or coated. In a preferred embodiment, the flavoring matrix composition forms a glaze on the surface of the food on which the flavoring matrix composition was layered or coated.

Thus, the present invention also provides a food product, which comprises:
(A) a portion of food; and
(B) a flavoring matrix composition on at least one surface of said portion of food,
   wherein said flavoring matrix composition comprises:
(a) a flavoring or seasoning; and
(b) an edible, meltable matrix,
   wherein said seasoning is distributed within the matrix and wherein said composition exists in the form of a sheet.

As explained above, the food to which the seasoning composition is applied may be uncooked or only partially cooked. In this case, the food may be cooked immediately or soon after the application of the seasoning composition. Alternatively, the food may be packaged and stored after application of the seasoning composition and prior to cooking. In one embodiment, the food may be frozen after application of the seasoning composition and then cooked, preferably after thawing.

In another embodiment, the food to which the seasoning composition is applied may be already cooked. In this case, it may be preferred that the seasoning composition be applied to the food soon after cooking so that the food is still warm and the warmth of the food may melt the seasoning composition. Alternatively, the seasoning composition may be applied to a cooked food which is not warm and then the seasoned food may be warmed to melt the seasoning composition. Of course, the seasoning composition may also be applied to the food during the cooking of the food.

In still another embodiement, the present invention is a soluable flavoring matrix composition, comprising:
(a) a flavoring or seasoning; and
(b) an edible, soluble, meltable matrix,
   wherein said flavoring or seasoning is distributed within the matrix and wherein said composition exists in the form of a sheet.

In a related embodiment, the present invention provides a method for preparing a seasoned food, comprising:
(1) adding a flavoring matrix composition to a surface of a food,
wherein said flavoring matrix composition comprises:
(a) a flavoring or seasoning; and
(b) an edible, soluble, meltable matrix,
   wherein said flavoring or seasoning is distributed within the matrix and wherein said composition exists in the form of a sheet.

Thus, the present invention also provides a food product, which comprises:
(A) a portion of food; and
(B) a flavoring matrix composition on at least one surface of said portion of food,
   wherein said flavoring matrix composition comprises:
(a) a flavoring or seasoning; and
(b) an edible, soluble, meltable matrix,
   wherein said seasoning is distributed within the matrix and wherein said composition exists in the form of a sheet.

Other features of the invention will become apparent in the course of the following descriptions of exemplary embodiments which are given for illustration of the invention and are not intended to be limiting thereof.

### EXAMPLES

In the following examples, and throughout this specification, all parts and percentages are by weight, and all temperatures are in degrees Celsius, unless expressly stated to be otherwise. Where the solids content of a dispersion or solution is reported, it expresses the weight of solids based on the total weight of the dispersion or solution, respectively. Where a molecular weight is specified, it is the molecular weight range ascribed to the product by the commercial supplier, which is identified. Generally this is believed to be weight average molecular weight.

### Example 1

### Composition for Retail Consumer Microwave Oven

The ingredients in Table 1 were utilized in the following procedure in the indicated amounts.

TABLE 1

| | Amount (% by weight, based on total |
|---|---|
| Ingredient | weight) |
| Pectin | 004.00% |
| Xanthan | 000.15% |
| Granulated Sugar | 019.89% |
| Glycerin | 015.00% |
| Seasoning Blend, Flavor or Extract | 005.00% |
| Sodium Citrate, Dihydrate | 000.30% |
| Citric Acid, Anhydrous | 000.30% |
| Calcium Citrate | 000.08% |
| Water | 055.28% |
| Total | 100.00% |

Procedure:

1. Add pectin and xanthan gum to glycerin and mix until completely dispersed.

2. Add gum/glycerin mix to water while stirring rapidly using a mixer.

3. Heat to 85° C. while stirring rapidly; avoid air incorporation. Add sugar.

4. Add sodium citrate, citric acid, calcium citrate and seasoning blend, flavor or extract; mix until evenly dispersed.

5. Pour the hot, mixture onto a non-stick board.

6. Drawdown to thickness of 1.0 to 2.4 mm. Cool to set. Dry if necessary.

7. Cut slices into pieces appropriate to the application.

8. Perforate the entire slice with narrow slits 1.6 mm apart using the perforation procedure described below.

Perforation Procedure:

1. Perforate entire seasoning slice with narrow slits 1.6 mm apart, using a Jaccard Super Meat Tenderizer.

2. Description of tenderizer—3 rows of 16 flat blades, each grouped to form a rectangle made up of a total 48 flat blades (3 1/8 inch long by 1/2-inch wide). The rows are 3/16 inches apart and each blade is 1/8 inch apart. Each flat blade measures 1/16 inch wide by 1/32 inch deep.

3. The entire surface of the seasoning slice is perforated vertically and then the tenderizer is rotated to horizontally perforate the same surface. For complete perforation of a seasoning slice cut to fit a chicken breast, 3 vertical movements and 3 horizontals are required.

### Example 2

### Composition for Retail Consumer Oven

The ingredients in Table 2 were utilized in the following procedure in the indicated amounts.

TABLE 2

| | Amount (% by weight, based on total |
|---|---|
| Ingredient | weight) |
| Pectin | 005.00% |
| Xanthan | 000.15% |
| Granulated Sugar | 020.50% |
| Glycerin | 015.00% |
| Seasoning Blend, Flavor or Extract | 005.00% |
| Sodium Citrate, Dihydrate | 000.30% |
| Citric Acid, Anhydrous | 000.30% |
| Calcium Citrate | 000.08% |
| Water | 053.67% |
| Total | 100.00% |

Procedure:

1. Add pectin and xanthan gum to glycerin and mix until completely dispersed.

2. Add gum/glycerin mix to water while stirring rapidly using a mixer.

3. Heat to 85° C. while stirring rapidly; avoid air incorporation. Add sugar.

4. Add sodium citrate, citric acid, calcium citrate and seasoning blend, flavor or extract; mix until evenly dispersed.

5. Pour the hot, mixture onto a non-stick board.

6. Drawdown to thickness of 1.0 to 2.4 mm. Cool to set. Dry if necessary.

7. Cut slices into pieces appropriate to the application.

8. Perforate the entire slice with narrow slits 1.6 mm apart using the perforation procedure described in Example 1.

### Example 3

### Composition for Food Service Flame Broiler

The ingredients in Table 3 were utilized in the following procedure in the indicated amounts.

TABLE 3

| | Amount (% by weight, based on total |
|---|---|
| Ingredient | weight) |
| Carrageenan | 000.90% |
| Locust Bean Gum | 000.68% |
| Granulated Sugar | 006.00% |
| Glycerin | 012.60% |
| Seasoning Blend, Flavor or Extract | 007.50% |
| Water | 071.72% |
| Total | 100.00% |

Procedure:

1. Add gums to glycerin and mix until completely dispersed.

2. Add gum/glycerin mix to water while stirring rapidly using a mixer.

3. Heat to 85° C. while stirring rapidly; avoid air incorporation. Add sugar.

4. Add seasoning blend, flavor or extract; mix until evenly dispersed.

5. Pour the hot, mixture onto a non-stick board.

6. Draw down to thickness of 1.0 to 2.4 mm. Cool to set. Dry if necessary.

7. Cut slices into pieces appropriate to the application.

8. Perforate the entire slice with narrow slits 1.6 mm apart using the perforation procedure described in Example 1.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A favoring matrix composition, comprising:
(a) a flavoring or seasoning; and
(b) an edible, meltable matrix,
wherein said flavoring or seasoning is distributed within the matrix and wherein said composition exists in the form of a sheet.

2. The composition of claim 1, wherein said sheet is perforated with a plurality of holes.

3. The composition of claim 1, wherein said edible, meltable matrix comprises one or more food polymers.

4. A method for preparing a flavoring matrix composition according to claim 1, comprising:
(1) heating a mixture of an edible, meltable matrix material and potable liquid, to obtain a first liquid mixture;
(2) adding a flavoring or seasoning to said first liquid mixture, to obtain a second liquid mixture; and
(3) cooling said second liquid mixture, to obtain said flavoring matrix composition.

5. The method of claim 4, further comprising:
(4) perforating said sheet with a plurality of holes.

6. The method of claim 4, wherein said edible, meltable matrix comprises one or more food polymers.

7. A method for preparing a seasoned food, comprising:
(1) adding a flavoring matrix composition according to claim 1 to a surface of a food, to obtain a seasoned food.

8. The method of claim 7, wherein said sheet is perforated with a plurality of holes.

9. The method of claim 7, wherein said food is uncooked.

10. The method of claim 9, further comprising:
(2) cooking said seasoned food.

11. The method of claim 7, wherein said food is cooked.

12. The method of claim 7, wherein said edible, meltable matrix comprises one or more food polymers.

13. A food product, which comprises:
(A) a portion of food; and
(B) a flavoring matrix composition according to claim 1 on at least one surface of said portion of food.

14. The food product of claim 13, wherein said sheet is perforated with a plurality of holes.

15. The food product of claim 13, wherein said portion of food is uncooked.

16. The food product of claim 13, wherein said portion of food is cooked.

17. The food product of claim 13, wherein said edible, meltable matrix comprises one or more food polymers.
